(19) United States
(12) Patent Application Publication
(10) Pub. No.: US 2025/0374198 A1
(43) Pub. Date: Dec. 4, 2025

(54) DATA PROCESSING METHOD, APPARATUS, DEVICE, AND STORAGE MEDIUM

(71) Applicants: China Mobile Communication Co., Ltd Research Institute, Beijing (CN); China Mobile Communications Group Co., Ltd., Beijing (CN)

(72) Inventors: Dan SONG, Beijing (CN); Xiaoxiong SONG, Beijing (CN); Songhe LU, Beijing (CN); Nan LI, Beijing (CN); Xiaodong XU, Beijing (CN); Nan HU, Beijing (CN); Chunjie FENG, Beijing (CN)

(21) Appl. No.: 19/110,187

(22) PCT Filed: Sep. 7, 2023
(86) PCT No.: PCT/CN2023/117416

§ 371 Date: Mar. 10, 2025

(30) Foreign Application Priority Data
Sep. 9, 2022 (CN) 202211105077.6

(51) Int. Cl. H04W 52/02

(52) U.S. Cl. CPC H04W 52/027

(57) ABSTRACT

A data processing method, apparatus, device, and storage medium are provided. The method includes: determining a probability proportion of multiple terminals in an operational network at different output powers; and determining the power consumption of each terminal among the multiple terminals at the different output powers; calculating a total power consumption of each terminal based on the probability proportion and the power consumption.

### CROSS REFERENCE OF RELATED APPLICATION

The present disclosure claims a priority of Chinese patent disclosure No. 202211105077.6 filed on Sep. 9, 2022, which are incorporated herein by reference in its entirety.

### TECHNICAL FIELD

The present disclosure relates to the field of wireless communication technologies, and in particular, to a data processing method, an apparatus, a device, and a storage medium.

### BACKGROUND

Currently, the schemes for estimating terminal power consumption are relatively singular, typically relying on typical terminal service models as terminal power consumption models to estimate terminal power consumption. However, the actual power consumption of a terminal is not only related to the service model used by the terminal. In other words, for the same terminal, even if the same service model is used, the actual power consumption of the terminal may differ under certain circumstances. It can be seen that the scheme of solely using the service model as the power consumption evaluation model has limitations and cannot accurately estimate the actual power consumption of the terminal.

### SUMMARY

In view of this, the embodiments of the present disclosure is to provide a data processing method, an apparatus, a device, and a storage medium.

The technical solutions of the embodiments of the present disclosure are implemented as follows:

At least one embodiment of the present disclosure provides a data processing method, where the method includes:
determining a probability proportion of multiple terminals in an operational network at different output powers; and determining the power consumption of each terminal among the multiple terminals at the different output powers;
calculating a total power consumption of each terminal based on the probability proportion and the power consumption.

Furthermore, according to at least one embodiment of the present disclosure, the determining the power consumption of each terminal among the multiple terminals at the different output powers includes:
for each terminal, determining the power consumption of the terminal at the different output powers based on the different output powers and the efficiency of the terminal in the operational network.

Furthermore, according to at least one embodiment of the present disclosure, the calculating the total power consumption of each terminal based on the probability proportion and the power consumption includes:
for each terminal, multiplying the power consumption of the terminal at the different output powers by the corresponding probability proportion to obtain multiple first values;
summing the multiple first values to obtain a second value; and
using the second value as the total power consumption of the terminal.

Furthermore, according to at least one embodiment of the present disclosure, the determining the power consumption of each terminal among the multiple terminals at the different output powers includes:

for each terminal, determining the power consumption of the terminal at the different output powers when the terminal is in a screen-off state and executing a specific continuous uplink service.

Furthermore, according to at least one embodiment of the present disclosure, the calculating the total power consumption of each terminal based on the probability proportion and the power consumption includes:
storing the determined probability proportion and power consumption;
calculating the total power consumption of each terminal based on the probability proportion and power consumption stored locally.

Furthermore, according to at least one embodiment of the present disclosure, the method further includes:
determining a probability proportion of power amplifiers in the multiple terminals in the operational network at different output powers; and determining the power consumption of the power amplifier in each terminal at the different output powers;
calculating a total power consumption of the power amplifier in each terminal based on the probability proportion and the power consumption.

At least one embodiment of the present disclosure provides a data processing apparatus, including:
a first processing unit, configured to determine a probability proportion of multiple terminals in an operational network at different output powers;
a second processing unit, configured to determine the power consumption of each terminal among the multiple terminals at the different output powers;
a third processing unit, configured to calculate a total power consumption of each terminal based on the probability proportion and the power consumption.

At least one embodiment of the present disclosure provides a data processing apparatus, including:
a communication interface;
a processor, configured to: determine a probability proportion of multiple terminals in an operational network at different output powers; determine the power consumption of each terminal among the multiple terminals at the different output powers; and calculate a total power consumption of each terminal based on the probability proportion and the power consumption.

At least one embodiment of the present disclosure provides a network device, including a processor and a memory for storing a computer program executable on the processor,
where the processor is configured to run the computer program to perform the method hereinabove.

At least one embodiment of the present disclosure provides a computer-readable storage medium, having stored therein a computer program, where the computer program, when executed by a processor, implements the method hereinabove.

The data processing method, the apparatus, the device, and the storage medium provided by the embodiments of the present disclosure determine the probability proportion of multiple terminals in an operational network at different output powers; determine the power consumption of each terminal among the multiple terminals at the different output powers; and calculate the total power consumption of each terminal based on the probability proportion and the power consumption. The technical solutions provided by the embodiments of the present disclosure combine the actual output power and power consumption of terminals in the operational network to estimate the total power consumption of the terminals, thereby improving the accuracy of terminal power consumption estimation compared to the related art that uses terminal service models to estimate terminal power consumption.

### BRIEF DESCRIPTION OF THE DRAWINGS

FIG. 1 is a schematic diagram of a service model for estimating terminal power consumption in the related art;

FIG. 2 is a schematic diagram of the implementation process of the data processing method according to an embodiment of the present disclosure;

FIG. 3 is a first schematic diagram of the specific implementation process of the data processing method according to an embodiment of the present disclosure;

FIG. 4 is a second schematic diagram of the specific implementation process of the data processing method according to an embodiment of the present disclosure;

FIG. 5 is a schematic diagram of the structure of the data processing apparatus according to an embodiment of the present disclosure; and

FIG. 6 is a schematic diagram of the structure of the network device according to an embodiment of the present disclosure.

### DETAILED DESCRIPTION

Before introducing the technical solutions of the embodiments of the present disclosure, the related art is first explained.

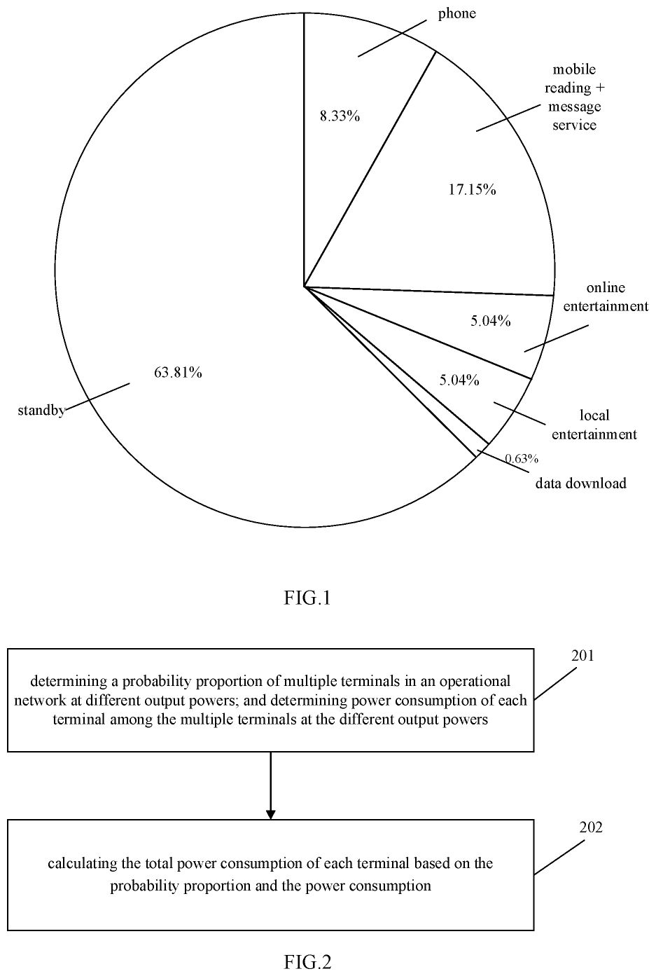

In the related art, FIG. 1 is a schematic diagram of a service model for estimating terminal power consumption in the related art. As shown in FIG. 1, the current schemes for estimating terminal power consumption are relatively singular, typically relying on typical terminal service models as terminal power consumption models to estimate terminal power consumption.

However, the actual power consumption of a terminal is not only related to the service model used by the terminal but also strongly correlated with the actual network state in which the terminal is located. In other words, a terminal in a good network coverage area, for example, RSRP>−90 dBm, usually has a lower output power and lower power consumption; while a terminal in a poor network coverage area, for example, RSRP<−110 dBm, usually has a higher output power, resulting in higher power consumption, where RSRP refers to Reference Signal Received Power.

In other words, for the same terminal, even if the same service model is used, if the terminal is in different network coverage states, the actual power consumption of the user's terminal will also be different. It can be seen that the scheme of solely using the service model as the power consumption evaluation model has limitations and cannot accurately estimate the actual power consumption of the terminal.

Secondly, the service models in the related art are suitable for evaluating the power consumption of the application processing system part of terminal products (Application Processor (AP)+Graphics Processing Unit (GPU), etc.). The related art also lacks methods for effectively evaluating the power consumption of the communication system part of terminal products in the operational network (BaseBand IC (BBIC)+Radio Frequency IC (RFIC)+Radio Frequency Front-end Modules (RF FEM), etc.).

In addition, when the terminal is in the screen-off state, the Power Amplifier (PA) is a major power consumer in the terminal's power consumption composition. For example, when the terminal is transmitting at full power, in the screen-off state, the PA power consumption can account for more than 80% of the terminal's total power consumption. The power amplifier will increase or decrease the output power according to the current network coverage situation of the terminal or the output power indication requirements from the network side, thereby affecting the terminal's power consumption. For the major power consumer in the terminal, the power amplifier, the current power consumption evaluation methods only evaluate the average current of the PA and do not consider the characteristics of the operational network, making it impossible to evaluate the power consumption performance of the power amplifier in the actual operational network. In other words, the related art does not have technologies or methods for evaluating the power consumption performance of the terminal's power amplifier in the operational network, and terminal manufacturers lack power consumption-related selection references when choosing power amplifiers based on the characteristics of the operational network.

Based on this, in the embodiments of the present disclosure, the probability proportion of multiple terminals in the operational network at different output powers is determined; the power consumption of each terminal among the multiple terminals at the different output powers is determined; and the total power consumption of each terminal is calculated based on the probability proportion and the power consumption.

FIG. 2 is a schematic diagram of the implementation process of the data processing method according to an embodiment of the present disclosure. As shown in FIG. 2, the method includes steps 201 to 202:

Step 201: determining a probability proportion of multiple terminals in an operational network at different output powers; and determining power consumption of each terminal among the multiple terminals at the different output powers.

It can be understood that the operational network may include:
the operational network within a target location;
or,
the operational network within a target city;
or,
the operational network within a target country;
or,
the operational network within a target continent.

In other words, the scope of the “operational network” can be large or small. For example, it can be the operational network within a factory, or the operational network within a city, or the operational network within a country, or the operational network within the whole Asia.

As an implementation, the determining the probability proportion of multiple terminals in the operational network at different output powers may include:

the network management platform collects network management data from the base station side, processes the network management data collected from the base station side, and obtains the probability proportion of multiple terminals in the operational network at different output powers.

Here, the network management platform determining the probability proportion of multiple terminals in the operational network at different output powers may specifically include:

Step 1: The network management platform collects network management data from the base station side.

Here, the network management data may refer to the Power Headroom Report (PHR).

Here, when multiple terminals access the network, the base station configures each terminal to periodically report the PHR. When each terminal is in the connected state and performing uplink services, each terminal periodically reports the PHR; where the PHR carries PH and Pcmax information. PH represents the cell power headroom, and Pcmax represents the maximum output power.

Step 2: The network management platform parses the PHR reported by each terminal to the base station to obtain the PH and Pcmax information.

Step 3: When the PH is greater than or equal to 0, calculate the actual output power of each terminal in the operational network according to the following formula (1). When the PH is less than 0, calculate the actual output power of each terminal in the operational network according to the following formula (2).

$${P}_{c max} - PH = {P}_{out} \qquad ( 1 )$$

$$PH - {P}_{c max} = {P}_{out} \qquad ( 2 )$$

where Pₒᵤₜ represents the actual output power of the terminal.

Step 4: The network management platform counts the total number of multiple terminals and counts the number of terminals at each output power point. Based on the counted total number of multiple terminals and the number of terminals at each output power point, calculate the probability proportion of multiple terminals at different output powers.

Assuming that the output powers calculated according to the above formulas (1) and (2) include 10 dBm, 20 dBm, and 30 dBm, the total number of multiple terminals counted is 100, the number of terminals with an output power of 10 dBm is 10, the number of terminals with an output power of 20 dBm is 20, and the number of terminals with an output power of 30 dBm is 30, then the probability proportions are: 10/100=10%, 20/100=20%, 30/100=30%.

It should be noted that the network management platform can count the network management data, i.e., PHR, reported by all base stations under its jurisdiction within a T period. According to the above steps 1 to 4, the real-time output power and probability proportion of each terminal initiating uplink services within the T period can be obtained, i.e., the percentage of the number of terminals with a certain dBm output power to the total number of terminals. Then, a data graph of the output power points and probability proportions of each terminal can be drawn.

Taking T=24 hours as an example, by fitting the trend graph obtained within 24 hours, the current daily power distribution trend graph can be obtained (the main power aggregation points can be found), and a statistical model with the output power as the horizontal coordinate and the daily distribution as the vertical coordinate can be obtained. Similarly, the current statistical model of the base station coverage area under the jurisdiction of the network management platform for each month and year can be obtained, and the main power aggregation points at each stage can be further found.

As another implementation, the determining the probability proportion of multiple terminals in the operational network at different output powers may include:

the network management platform obtains the probability proportion of multiple terminals in the operational network at different output powers from the base station side.

Here, the network management platform determining the probability proportion of multiple terminals in the operational network at different output powers may specifically include:

Step 1: The base station obtains the network management data reported by multiple terminals.

Here, the network management data may refer to the PHR.

Here, when multiple terminals access the network, the base station configures each terminal to periodically report the PHR. When each terminal is in the connected state and performing uplink services, each terminal periodically reports the PHR; where the PHR carries PH and Pcmax information.

Step 2: The base station parses the PHR reported by each terminal to obtain the PH and Pcmax information.

Step 3: When the PH is greater than or equal to 0, calculate the actual output power of each terminal in the operational network according to the above formula (1). When the PH is less than 0, calculate the actual output power of each terminal in the operational network according to the above formula (2).

Step 4: The base station counts the total number of multiple terminals and counts the number of terminals at each output power point. Based on the counted total number of multiple terminals and the number of terminals at each output power point, calculate the probability proportion of multiple terminals at different output powers.

Assuming that the output powers calculated according to the above formulas (1) and (2) include 10 dBm, 20 dBm, and 30 dBm, the total number of multiple terminals counted is 100, the number of terminals with an output power of 10 dBm is 10, the number of terminals with an output power of 20 dBm is 20, and the number of terminals with an output power of 30 dBm is 30, then the probability proportions are: 10/100=10%, 20/100=20%, 30/100=30%.

Step 5: The base station reports the calculated probability proportion of multiple terminals at different output powers to the network management platform.

As yet another implementation, the determining the probability proportion of multiple terminals in the operational network at different output powers may include:

Here, the network management platform determining the probability proportion of multiple terminals in the operational network at different output powers may specifically include:

Step 1: The network management platform collects network management data from the base station side.

Here, the network management data may refer to the PHR.

Here, when multiple terminals access the network, the base station configures each terminal to periodically report the PHR. When each terminal is in the connected state and performing uplink services, each terminal periodically reports the PHR; where the PHR carries PH and Pcmax information.

Step 2: The network management platform parses the PHR reported by each terminal to obtain the PH and Pcmax information.

Step 3: The network management personnel import the parsed PH and Pcmax information into an Excel table installed on the network management platform.

Step 4: In the Excel table, when the PH is greater than or equal to 0, calculate the actual output power of each terminal in the operational network according to the above formula (1); when the PH is less than 0, calculate the actual output power of each terminal in the operational network according to the above formula (2).

Step 5: The network management platform counts the total number of multiple terminals and counts the number of terminals at each output power point. Based on the counted total number of multiple terminals and the number of terminals at each output power point, the probability proportion of multiple terminals at different output powers is calculated.

Assuming that the output powers calculated according to the above formulas (1) and (2) include 10 dBm, 20 dBm, and 30 dBm, the total number of multiple terminals counted is 100, the number of terminals with an output power of 10 dBm is 10, the number of terminals with an output power of 20 dBm is 20, and the number of terminals with an output power of 30 dBm is 30, then the probability proportions are: 10/100=10%, 20/100=20%, 30/100=30%.

In one embodiment, the determining the power consumption of each terminal among the multiple terminals at the different output powers includes:

for each terminal, determining the power consumption of the terminal at the different output powers based on the different output powers and the efficiency of the terminal in the operational network.

It should be noted that determining the power consumption of each terminal at different output powers requires the use of specialized power consumption testing tools.

In other words, after determining the different output powers of each terminal in the operational network, specialized power consumption testing tools are used to test the efficiency of the terminal at different output powers.

In other words, terminal manufacturers can use specialized power consumption testing tools to test the efficiency of the terminal at different output powers and provide the results to the network management platform; or, laboratory personnel can use specialized power consumption testing tools to test the efficiency of the terminal at different output powers and store the test results on the network management platform.

Here, the power consumption of each terminal at different output powers can be calculated according to the following formula (3):

$${P}_{0 \_ n} = {P}_{out \_ n} \div {E}_{n} \qquad ( 3 )$$

where P_{0_n} represents the power consumption of the terminal at different output powers, P_{out_n} represents the actual output power of the terminal, and Eₙ represents the efficiency of the terminal at different output powers.

In one embodiment, the determining the power consumption of each terminal among the multiple terminals at the different output powers includes:

for each terminal, determining the power consumption of the terminal at the different output powers when the terminal is in a screen-off state and executing a specific continuous uplink service.

Step 202: calculating the total power consumption of each terminal based on the probability proportion and the power consumption.

In one embodiment, the calculating the total power consumption of each terminal based on the probability proportion and the power consumption includes:
storing the determined probability proportion and power consumption locally;
calculating the total power consumption of each terminal based on the probability proportion and power consumption stored locally.

In other words, the determined probability proportion and power consumption can be stored locally first, and then the stored probability proportion and power consumption can be used to calculate the total power consumption of each terminal.

In one embodiment, the calculating the total power consumption of each terminal based on the probability proportion and the power consumption includes:
for each terminal, multiplying the power consumption of the terminal at different output powers by the corresponding probability proportion to obtain multiple first values;
summing the multiple first values to obtain a second value;
using the second value as the total power consumption of the terminal.

Here, the product of the power consumption of the terminal at different output powers and the corresponding probability proportion can be calculated according to the following formula (4):

$${P}_{prob\_n} = {P}_{0 \_ n} \times {P}_{n} \qquad ( 4 )$$

where P_{prob_n} represents the product of the power consumption of the terminal at different output powers and the corresponding probability proportion, P_{0_n} represents the power consumption of the terminal at different output powers P_{out_n}, and Pₙ represents the probability proportion of the terminal at different output powers P_{out_n}. n ranges from 1 to N, where Nis an integer greater than 1.

Here, the total power consumption of each terminal, i.e., the second value, can be calculated according to the following formula (5):

$${P}_{sum} = {P}_{prob \_ 1} + {P}_{prob \_ 2} + … + {P}_{prob\_n} \qquad ( 5 )$$

where Pₛᵤₘ represents the total power consumption of the terminal, P_{prob_1} represents the first value of the terminal at output power P_{out_1}, P_{prob_2} represents the first value of the terminal at output power P_{out_2}, and so on, P_{prob_n} represents the first value of the terminal at output power P_{out_n}.

In one embodiment, the method further includes:
determining the probability proportion of power amplifiers in the multiple terminals in the operational network at different output powers; and determining the power consumption of the power amplifier in each terminal at the different output powers;
calculating the total power consumption of the power amplifier in each terminal based on the probability proportion and the power consumption.

It can be understood that determining the probability proportion of power amplifiers in the multiple terminals in the operational network at different output powers is similar to determining the probability proportion of multiple terminals in the operational network at different output powers, and will not be repeated here. Determining the power consumption of the power amplifier in each terminal at different output powers is similar to determining the power consumption of each terminal at different output powers, and will not be repeated here.

It can be understood that determining the probability proportion of power amplifiers in the multiple terminals in the operational network at different output powers; and determining the power consumption of the power amplifier in each terminal at the different output powers when the terminal is in a screen-off state and executing a specific continuous uplink service, so that the total power consumption of the power amplifier in each terminal can be calculated based on the determined probability proportion and power consumption.

It should be noted that the data processing method provided by the embodiments of the present disclosure can also be used to evaluate the total power consumption of the power amplifier in the terminal in the operational network. The method for determining the total power consumption of the power amplifier in the terminal is similar to the method for determining the total power consumption of the terminal, and will not be repeated here.

The embodiments of the present disclosure have the following advantages:
(1) Determining the probability proportion of multiple terminals in the operational network at different output powers; determining the power consumption of each terminal among the multiple terminals at the different output powers; and calculating the total power consumption of each terminal based on the probability proportion and the power consumption, compared to the related art that uses terminal service models to estimate terminal power consumption, can combine the actual output power and power consumption of terminals in the operational network, thereby improving the accuracy of terminal power consumption estimation, making up for the defects and deficiencies in the terminal power consumption estimation system in the related art, and further improving the terminal power consumption estimation system.
(2) Combining the actual output power and power consumption of the terminal in the screen-off state can significantly improve the accuracy of terminal power consumption estimation in the screen-off state.
(3) It is suitable for evaluating the total power consumption of the terminal and also for evaluating the total power consumption of the power amplifier in the terminal.

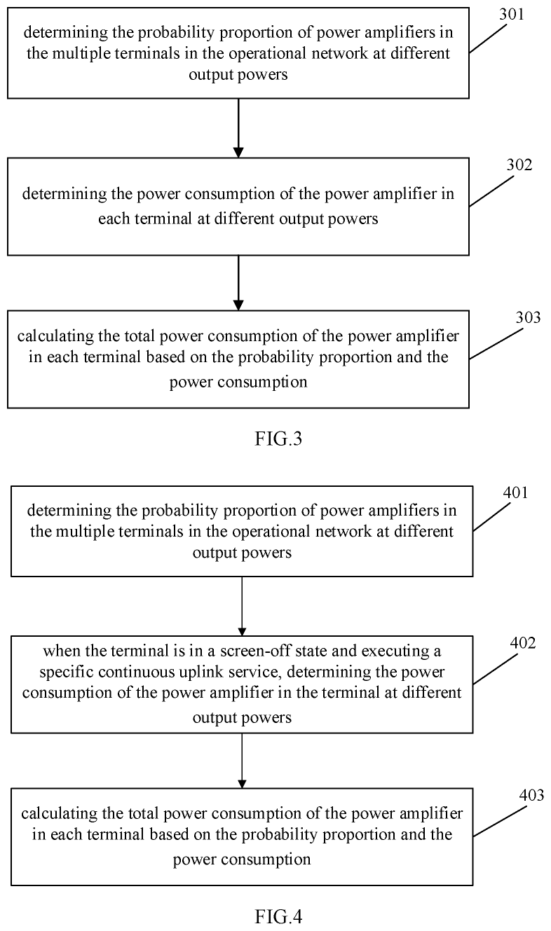

FIG. 3 is a schematic diagram of the specific implementation process of the data processing method according to an embodiment of the present disclosure. As shown in FIG. 3, the method includes steps 301 to 303:

Step 301: determining the probability proportion of power amplifiers in the multiple terminals in the operational network at different output powers.

Here, the probability proportion can also be used to obtain the proportion model of the output power of the power amplifier in the terminal in the operational network; this proportion model represents the correspondence between the output power of the power amplifier in the terminal and the probability proportion.

Step 302: determining the power consumption of the power amplifier in each terminal at different output powers.

Here, the power consumption may refer to consumption of power.

Here, specialized power consumption testing tools can be used to test the efficiency of the power amplifier in the terminal at different output powers.

Here, the power consumption of the power amplifier in the terminal at different output powers can be calculated according to the following formula (6):

$${PPA}_{\_ n} = {PPA}_{out\_n} \div {PAE}_{n} \qquad ( 6 )$$

where PPA_ₙ represents the power consumption of the power amplifier in the terminal at different output powers, PPA_{out_n} represents the different output powers of the power amplifier in the terminal, and PAEₙ represents the efficiency of the power amplifier in the terminal at different output powers.

Here, multiplying PPA_ₙ by a period of time can obtain the energy consumption of the power amplifier in the terminal during that period of time.

Here, the power consumption of the power amplifier in the terminal at different output powers can also be calculated according to the following formula (7):

$${PPA}_{\_ n} = {VccPA}_{\_ n} \times {IccPA}_{\_ n} \qquad ( 7 )$$

where PPA_ₙ represents the power consumption of the power amplifier in the terminal at different output powers, VccPA_ₙ represents the working voltage of the power amplifier in the terminal obtained through testing, and IccPA_ₙ represents the working current of the power amplifier in the terminal obtained through testing.

Step 303: calculating the total power consumption of the power amplifier in each terminal based on the probability proportion and the power consumption.

Here, the product of the power consumption of the power amplifier in each terminal at different output powers and the corresponding probability proportion can be calculated according to the following formula (8):

$${PPA}_{prob\_n} = {PPA}_{\_ n} \times {P}_{n} \qquad ( 8 )$$

where PPA_{prob_n} represents the product of the power consumption of the power amplifier in each terminal at different output powers PPA_{out_n} and the corresponding probability proportion, PPA_ₙ represents the power consumption of the power amplifier in the terminal at different output powers PPA_{out_n}, and Pₙ represents the probability proportion of the power amplifier in the multiple terminals in the operational network at different output powers PPA_{out_n}. n ranges from 1 to N, where N is an integer greater than 1.

Here, the total power consumption of the power amplifier in each terminal can be calculated according to the following formula (9):

$${PPA}_{sum} = {PPA}_{prob \_ 1} + {PPA}_{prob \_ 2} + … + {PPA}_{prob\_n} \qquad ( 9 )$$

where PPAₛᵤₘ represents the total power consumption of the power amplifier in each terminal.

Table 1 is a schematic diagram of the product of the probability proportion and the corresponding power consumption of the power amplifier (PA) in the terminal at different output powers. As shown in Table 1, taking the output power of the PA in the terminal as P1 as an example, the probability proportion of the PA in the terminal at output power P1 is B1%, and the power consumption of the PA in the terminal at output power P1 is P1/A1, so the product of the power consumption and the corresponding probability proportion of the PA in the terminal at output power PAI is B1×P1/A1.

TABLE 1

| | | | | Product of power consumption |
|---|---|---|---|---|
| | | Probability proportion | Power | of power amplifier (PA) in the |
| | | at different output | Consumption | terminal at different output |
| Output | | power in the | at Different | power and corresponding |
| Power | Efficiency | operational network | Output Power | probability proportion |
| mW | % | % | mW | mW |
| P1 | A1% | B1% | 100 × P1/A1 | B1 × P1/A1 |
| P2 | A2% | B2% | 100 × P2/A2 | B2 × P2/A2 |
| P3 | A3% | B3% | 100 × P3/A3 | B3 × P3/A3 |
| P4 | A4% | B4% | 100 × P4/A4 | B4 × P4/A4 |
| P5 | A5% | B5% | 100 × P5/A5 | B5 × P5/A5 |
| P6 | A6% | B6% | 100 × P6/A6 | B6 × P6/A6 |
| P7 | A7% | B7% | 100 × P7/A7 | B7 × P7/A7 |
| P8 | A8% | B8% | 100 × P8/A8 | B8 × P8/A8 |
| P9 | A9% | B9% | 100 × P9/A9 | B9 × P9/A9 |
| P10 | A10% | B10% | 100 × P10/A10 | B10 × P10/A10 |
| P11 | A11% | B11% | 100 × P11/A11 | B11 × P11/A11 |
| P12 | A12% | B12% | 100 × P12/A12 | B12 × P12/A12 |
| P13 | A13% | B13% | 100 × P13/A13 | B13 × P13/A13 |
| P14 | A14% | B14% | 100 × P14/A14 | B14 × P14/A14 |
| P15 | A15% | B15% | 100 × P15/A15 | B15 × P15/A15 |
| P16 | A16% | B16% | 100 × P16/A16 | B16 × P16/A16 |
| P17 | A17% | B17% | 100 × P17/A17 | B17 × P17/A17 |
| P18 | A18% | B18% | 100 × P18/A18 | B18 × P18/A18 |
| P19 | A19% | B19% | 100 × P19/A19 | B19 × P19/A19 |
| P20 | A20% | B20% | 100 × P20/A20 | B20 × P20/A20 |
| P21 | A21% | B21% | 100 × P21/A21 | B21 × P21/A21 |
| P22 | A22% | B22% | 100 × P22/A22 | B22 × P22/A22 |
| P23 | A23% | B23% | 100 × P23/A23 | B23 × P23/A23 |
| P24 | A24% | B24% | 100 × P24/A24 | B24 × P24/A24 |
| P25 | A25% | B25% | 100 × P25/A25 | B25 × P25/A25 |
| . . . | . . . | . . . | . . . | . . . |

Table 2 is a schematic diagram of the total power consumption of the power amplifier (PA) in the terminal. As shown in Table 2, the probability proportion of the PA in the terminal at different output powers is determined, and the power consumption of the PA in the terminal at different output powers is determined. Based on the determined probability proportion and power consumption, the final total power consumption PPAsum of the PA can be obtained.

TABLE 2

| | | | | | Product of probability |
|---|---|---|---|---|---|
| | | | Probability proportion | Power | proportion of PA in the |
| | | | at different output | Consumption | terminal at different output |
| | | | power in the | at Different | power and corresponding |
| Output Powers | | Efficiency | operational network | Output Power | power consumption |
| dBm | mW | % | % | mW | mW |
| 5 | 3.16 | 0.70% | 1.000% | 451.75 | 4.52 |
| 6 | 3.98 | 0.80% | 1.000% | 497.63 | 4.98 |
| 7 | 5.01 | 1.00% | 2.000% | 501.19 | 10.02 |
| 8 | 6.31 | 2.00% | 4.000% | 315.48 | 12.62 |
| 9 | 7.94 | 3.00% | 10.000% | 264.78 | 26.48 |
| 10 | 10.00 | 4.00% | 10.000% | 250.00 | 25.00 |
| 11 | 12.59 | 5.00% | 1.000% | 251.79 | 2.52 |
| 12 | 15.85 | 6.00% | 1.000% | 264.15 | 2.64 |
| 13 | 19.95 | 8.00% | 2.000% | 249.41 | 4.99 |
| 14 | 25.12 | 9.00% | 1.000% | 279.10 | 2.79 |
| 15 | 31.62 | 10.00% | 10.000% | 316.23 | 31.62 |
| 16 | 39.81 | 6.00% | 20.000% | 663.51 | 132.70 |
| 17 | 50.12 | 8.00% | 5.000% | 626.48 | 31.32 |
| 18 | 63.10 | 9.00% | 5.000% | 701.06 | 35.05 |
| 19 | 79.43 | 10.00% | 1.000% | 794.33 | 7.94 |
| 20 | 100.00 | 12.00% | 2.000% | 833.33 | 16.67 |
| 21 | 125.89 | 15.00% | 8.000% | 839.28 | 67.14 |
| 22 | 158.49 | 18.00% | 8.000% | 880.50 | 70.44 |
| 23 | 199.53 | 20.00% | 4.000% | 997.63 | 39.91 |
| 24 | 251.19 | 24.00% | 2.000% | 1046.62 | 20.93 |
| 25 | 316.23 | 28.00% | 1.000% | 1129.38 | 11.29 |
| 26 | 398.11 | 30.00% | 1.000% | 1327.02 | 13.27 |
| | | | 100.00% | PPAsum | 574.85 |

In this example, the following advantages are achieved:

(1) It is suitable for evaluating the total power consumption of the power amplifier in the terminal, significantly optimizing the power consumption estimation system of the power amplifier in the terminal, improving the accuracy of power consumption estimation of the power amplifier in the terminal, and helping to optimize the power consumption performance of the power amplifier in the terminal, providing a reference for terminal manufacturers to select power amplifiers based on power consumption performance.

FIG. 4 is a schematic diagram of the specific implementation process of the data processing method according to another embodiment of the present disclosure. As shown in FIG. 4, the method includes steps 401 to 403:

Step 401: determining the probability proportion of power amplifiers in the multiple terminals in the operational network at different output powers.

Here, the probability proportion can also be used to obtain the proportion model of the output power of the terminal in the operational network; this proportion model represents the correspondence between the output power of the terminal and the probability proportion.

Step 402: when the terminal is in a screen-off state and executing a specific continuous uplink service, determining the power consumption of the power amplifier in the terminal at different output powers.

Here, the power consumption may refer to power consumption.

Here, when the terminal is in a screen-off state and executing a specific continuous uplink service, the power consumption of the power amplifier in the terminal at different output powers can be calculated according to the following formula (10):

$${PUE}_{\_ n} = {PUE}_{out\_n} \div {E}_{n} \qquad ( 10 )$$

where PUE_ₙ represents the power consumption of the power amplifier in the terminal at different output powers when the terminal is in a screen-off state and executing a specific continuous uplink service, PUE_{out_n} represents the different output powers of the power amplifier in the terminal when the terminal is in a screen-off state and executing a specific continuous uplink service, and Eₙ represents the efficiency of the power amplifier in the terminal at different output powers when the terminal is in a screen-off state and executing a specific continuous uplink service.

Step 403: calculating the total power consumption of the power amplifier in each terminal based on the probability proportion and the power consumption.

Here, the power consumption of the power amplifier in the terminal at different output powers can be obtained by combining the probability proportion of the power amplifier in the multiple terminals in the operational network at different output powers and the efficiency of the power amplifier in the terminal at different output powers. Then, the power consumption of the power amplifier in the terminal at different output powers can be summed to obtain the total power consumption of the power amplifier in the terminal.

Table 3 is a schematic diagram of the total power consumption of the power amplifier (PA) in the terminal. As shown in Table 3, the probability proportion of the PA in the terminal at different output powers is determined; when the terminal is in a screen-off state and executing a specific continuous uplink service, the power consumption of the PA in the terminal at different output powers is determined. Based on the determined probability proportion and power consumption, the final total power consumption PUEsum of the PA can be obtained.

TABLE 3

| | | | | | Product of power consumption |
|---|---|---|---|---|---|
| | | | Probability proportion | Power | of PA in the terminal at |
| | | | at different output | Consumption | different output power |
| | | | power in the | at Different | and corresponding |
| Output Power | | Efficiency | operational network | Output Power | probability proportion |
| dBm | mW | % | % | mW | mW |
| 5 | 3.16 | 1.00% | 20.000% | 316.23 | 63.25 |
| 6 | 3.98 | 2.00% | 15.000% | 199.05 | 29.86 |
| 7 | 5.01 | 2.00% | 2.000% | 250.59 | 5.01 |
| 8 | 6.31 | 3.00% | 2.000% | 210.32 | 4.21 |
| 9 | 7.94 | 4.00% | 1.000% | 198.58 | 1.99 |
| 11 | 10.00 | 5.00% | 1.000% | 200.00 | 2.00 |
| 11 | 12.59 | 6.00% | 1.000% | 209.82 | 2.10 |
| 12 | 15.85 | 7.00% | 1.000% | 226.41 | 2.26 |
| 13 | 19.95 | 9.00% | 1.000% | 221.70 | 2.22 |
| 14 | 25.12 | 3.00% | 2.000% | 837.30 | 16.75 |
| 15 | 31.62 | 5.00% | 3.000% | 632.46 | 18.97 |
| 16 | 39.81 | 7.00% | 2.000% | 568.72 | 11.37 |
| 17 | 50.12 | 13.00% | 1.000% | 385.53 | 3.86 |
| 18 | 63.10 | 20.00% | 1.000% | 315.48 | 3.15 |
| 19 | 79.43 | 4% | 2.000% | 1985.82 | 39.72 |
| 20 | 100.00 | 5.00% | 1.000% | 2000.00 | 20.00 |
| 21 | 125.89 | 6.00% | 2.000% | 2098.21 | 41.96 |
| 22 | 158.49 | 7.00% | 1.000% | 2264.13 | 22.64 |
| 23 | 199.53 | 10.00% | 4.000% | 1995.26 | 79.81 |
| 24 | 251.19 | 14.00% | 2.000% | 1794.20 | 35.88 |
| 25 | 316.23 | 18.00% | 15.000% | 1756.82 | 263.52 |
| 26 | 398.11 | 20.00% | 20.000% | 1990.54 | 398.11 |
| | | | | PUEsum | 1068.64 |

In this example, the following advantages are achieved:

(1) It evaluates the power consumption performance of the communication system part of different terminals when they are in the screen-off state and executing a specific continuous uplink service.

In other words, it provides an evaluation method for evaluating the power consumption performance of the communication system part of terminal products in the operational network (BaseBand IC (BBIC)+Radio Frequency IC (RFIC)+Radio Frequency Front-end Modules (RF FEM), etc.).

To implement the data processing method of the embodiments of the present disclosure, the embodiments of the present disclosure also provide a data processing apparatus. FIG. 5 is a schematic diagram of the structure of the data processing apparatus according to an embodiment of the present disclosure. As shown in FIG. 5, the apparatus includes:
a first processing unit 51, configured to determine the probability proportion of multiple terminals in the operational network at different output powers;
a second processing unit 52, configured to determine the power consumption of each terminal among the multiple terminals at the different output powers;
a third processing unit 53, configured to calculate the total power consumption of each terminal based on the probability proportion and the power consumption.

In one embodiment, the second processing unit 52 is further configured to:
for each terminal, determine the power consumption of the terminal at the different output powers based on the different output powers and the efficiency of the terminal in the operational network.

In one embodiment, the third processing unit 53 is further configured to:
for each terminal, multiply the power consumption of the terminal at different output powers by the corresponding probability proportion to obtain multiple first values;
sum the multiple first values to obtain a second value;
use the second value as the total power consumption of the terminal.

In one embodiment, the second processing unit 52 is further configured to:
for each terminal, determine the power consumption of the terminal at the different output powers when the terminal is in a screen-off state and executing a specific continuous uplink service.

In one embodiment, the third processing unit 53 is further configured to:
store the determined probability proportion and power consumption;
calculate the total power consumption of each terminal based on the probability proportion and power consumption stored locally.

In one embodiment, the apparatus is further configured to:
determine the probability proportion of power amplifiers in the multiple terminals in the operational network at different output powers; and determine the power consumption of the power amplifier in each terminal at the different output powers;
calculate the total power consumption of the power amplifier in each terminal based on the probability proportion and the power consumption.

In practical applications, the first processing unit 51, the second processing unit 52, and the third processing unit 53 can be implemented by a processor in the data processing apparatus.

It should be noted that the data processing apparatus provided by the above embodiments is only an example of the division of the above program modules when performing data processing. In practical applications, the above processing can be assigned to different program modules as needed, that is, the internal structure of the apparatus can be divided into different program modules to complete all or part of the above processing. In addition, the data processing apparatus provided by the above embodiments and the data processing method embodiments belong to the same concept, and the specific implementation process is detailed in the method embodiments, and will not be repeated here.

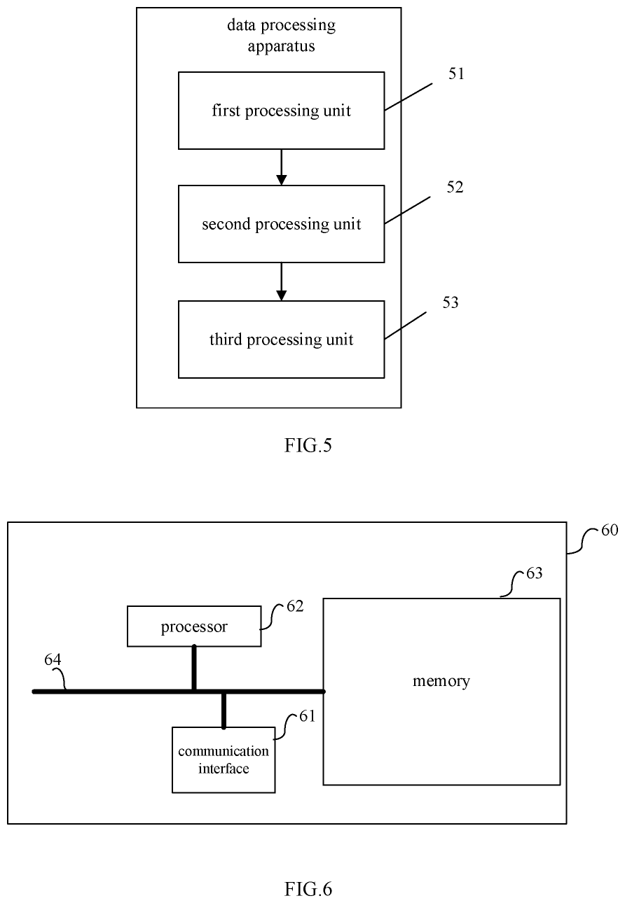

The embodiments of the present disclosure also provide a network device, as shown in FIG. 6, including:
a communication interface 61, capable of exchanging information with other devices;
a processor 62, connected to the communication interface 61, configured to execute the steps of the method provided by one or more technical solutions on the network device side when running a computer program. The computer program is stored in a memory 63.

It should be noted that the specific processing process of the processor 62 and the communication interface 61 is detailed in the method embodiments, and will not be repeated here.

Of course, in practical applications, the components of the network device 60 are coupled together through a bus system 64. It can be understood that the bus system 64 is used to implement connection communication between these components. The bus system 64 includes not only a data bus but also a power bus, a control bus, and a status signal bus. However, for clarity of description, all buses are labeled as the bus system 64 in FIG. 6.

The memory 63 in the embodiments of the present disclosure is used to store various types of data to support the operation of the network device 60. Examples of these data include: any computer program operating on the network device 60.

The methods disclosed in the embodiments of the present disclosure can be applied to the processor 62 or implemented by the processor 62. The processor 62 may be an integrated circuit chip with signal processing capabilities. In the implementation process, the steps of the above methods can be completed by hardware integrated logic circuits in the processor 62 or instructions in the form of software. The above processor 62 can be a general-purpose processor, a digital signal processor (DSP), or other programmable logic devices, discrete gates or transistor logic devices, discrete hardware components, etc. The processor 62 can implement or execute the methods, steps, and logic block diagrams disclosed in the embodiments of the present disclosure. A general-purpose processor can be a microprocessor or any conventional processor. The steps of the methods disclosed in the embodiments of the present disclosure can be directly embodied as being executed by a hardware decoding processor, or executed by a combination of hardware and software modules in the decoding processor. The software modules can be located in a storage medium, and the storage medium is located in the memory 63. The processor 62 reads the information in the memory 63 and completes the steps of the foregoing methods in combination with its hardware.

In an exemplary embodiment, the network device 60 can be implemented by one or more application-specific integrated circuits (ASICs), DSPs, programmable logic devices (PLDs), complex programmable logic devices (CPLDs), field-programmable gate arrays (FPGAs), general-purpose processors, controllers, microcontrollers (MCUs), microprocessors, or other electronic components, to execute the foregoing methods.

It can be understood that the memory (memory 63) in the embodiments of the present disclosure can be volatile memory or non-volatile memory, or can include both volatile and non-volatile memory. Among them, non-volatile memory can be read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, optical disks, or CD-ROM; magnetic surface memory can be disk memory or tape memory. Volatile memory can be random access memory (RAM), which is used as an external cache. By way of example but not limitation, many forms of RAM are available, such as static random access memory (SRAM), synchronous static random access memory (SSRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous link dynamic random access memory (SLDRAM), and direct memory bus random access memory (DRRAM). The memory described in the embodiments of the present disclosure is intended to include but not limited to these and any other suitable types of memory.

In an exemplary embodiment, the embodiments of the present disclosure also provide a storage medium, that is, a computer storage medium, specifically a computer-readable storage medium, for example, a memory including a stored computer program. The computer program can be executed by the processor 62 of the network device 60 to complete the steps of the method on the network device side. The computer-readable storage medium can be FRAM, ROM, PROM, EPROM, EEPROM, Flash Memory, magnetic surface memory, optical disks, or CD-ROM.

It should be noted that “first”, “second”, etc. are used to distinguish similar objects and do not need to be used to describe a specific order or sequence.

In addition, the technical solutions recorded in the embodiments of the present disclosure can be combined arbitrarily without conflict.

The above are only the preferred embodiments of the present disclosure and are not intended to limit the scope of the present disclosure.

1. A data processing method, comprising:
determining a probability proportion of multiple terminals at different output power; and determining power consumption of each terminal among the multiple terminals at the different output power;
calculating a total power consumption of each terminal based on the probability proportion and the power consumption.

2. The method according to claim 1, wherein determining the power consumption of each terminal among the multiple terminals at the different output power comprises:
determining, for each terminal, the power consumption of the terminal at the different output power based on the different output power and efficiency of the terminal.

3. The method according to claim 1, wherein calculating the total power consumption of each terminal based on the probability proportion and the power consumption comprises:
multiplying, for each terminal, the power consumption of the terminal at the different output power by the corresponding probability proportion to obtain multiple first values;
summing the multiple first values to obtain a second value; and
using the second value as the total power consumption of the terminal.

4. The method according to claim 1, wherein determining the power consumption of each terminal among the multiple terminals at the different output power comprises:
determining, for each terminal, the power consumption of the terminal at the different output power when the terminal is in a screen-off state and executing a specific continuous uplink service.

5. The method according to claim 1, wherein calculating the total power consumption of each terminal based on the probability proportion and the power consumption comprises:
storing the determined probability proportion and power consumption;
calculating the total power consumption of each terminal based on the probability proportion and power consumption stored locally.

6. The method according to claim 1, further comprising:
determining a probability proportion of power amplifiers in the multiple terminals at different output power; and determining power consumption of the power amplifier in each terminal at the different output power;
calculating a total power consumption of the power amplifier in each terminal based on the probability proportion and the power consumption.

7. (canceled)

8. A data processing apparatus, comprising:
a communication interface;
a processor, configured to: determine a probability proportion of multiple terminals at different output power; determine power consumption of each terminal among the multiple terminals at the different output power; and calculate a total power consumption of each terminal based on the probability proportion and the power consumption.

9. A network device, comprising a processor and a memory for storing a computer program executable on the processor,
wherein the processor is configured to run the computer program to perform the method according to claim 1.

10. A computer-readable storage medium, having stored therein a computer program, wherein the computer program, when executed by a processor, implements the method according to claim 1.

11. The data processing apparatus according to claim 8, wherein the processor is further configured to:
determine, for each terminal, the power consumption of the terminal at the different output power based on the different output power and efficiency of the terminal.

12. The data processing apparatus according to claim 8, wherein the processor is further configured to:
multiply, for each terminal, the power consumption of the terminal at the different output power by the corresponding probability proportion to obtain multiple first values;
sum the multiple first values to obtain a second value; and
use the second value as the total power consumption of the terminal.

13. The data processing apparatus according to claim 8, wherein the processor is further configured to:
determine, for each terminal, the power consumption of the terminal at the different output power when the terminal is in a screen-off state and executing a specific continuous uplink service.

14. The data processing apparatus according to claim 8, wherein the processor is further configured to:
store the determined probability proportion and power consumption;
calculate the total power consumption of each terminal based on the probability proportion and power consumption stored locally.

15. The data processing apparatus according to claim 8, wherein the processor is further configured to:
determine a probability proportion of power amplifiers in the multiple terminals at different output power; and determine power consumption of the power amplifier in each terminal at the different output power;
calculate a total power consumption of the power amplifier in each terminal based on the probability proportion and the power consumption.
